(19) United States
(12) Patent Application Publication
(10) Pub. No.: US 2022/0124869 A1
(43) Pub. Date: Apr. 21, 2022

(54) EMERGENCY CALLS WITH SERVICE REQUEST TRIGGERED FALLBACK

(71) Applicant: Telefonaktiebolaget LM Ericsson (publ), Stockholm (SE)

(72) Inventors: Ralf Keller, Würselen (DE); Afshin Abtin, Sollentuna (SE); Christer Gustafsson, Huddinge (SE); Peter Ramle, Mölnlycke (SE)

(21) Appl. No.: 17/423,752

(22) PCT Filed: Jan. 9, 2020
(86) PCT No.: PCT/IB2020/050156

§ 371 Date: Jul. 16, 2021

Related U.S. Application Data
(60) Provisional application No. 62/794,126, filed on Jan. 18, 2019.

(51) Int. Cl. H04W 76/50; H04W 36/00; H04W 4/90; H04W 36/14

(52) U.S. Cl. CPC H04W 76/50; H04W 36/0066; H04W 36/14; H04W 4/90; H04W 36/0033

(57) ABSTRACT

Systems and methods are disclosed for service request triggered fallback for an emergency service in a cellular communications system. Embodiments of a method performed by a wireless device for redirecting from a first wireless communication system to a second wireless communication system after having performed a service request in the first wireless communication system for an emergency call are also disclosed. In some embodiments, the method comprises transmitting a connection request message to a base station in the second wireless communication system as part of a connection establishment procedure whereby the wireless device establishes a connection to the second wireless communication system, the connection request message comprising an indication that a cause of connection establishment is an emergency. In this manner, the base station can provide emergency treatment for the connection request. Corresponding embodiments of a wireless device are also disclosed.

### RELATED APPLICATIONS

This application claims the benefit of provisional patent application Ser. No. 62/794,126, filed Jan. 18, 2019, the disclosure of which is hereby incorporated herein by reference in its entirety.

### TECHNICAL FIELD

The present disclosure relates to service request triggered fallback for emergency services from a first wireless communication system (e.g., a Fifth Generation (5G) System (5GS)) to a second wireless communication system (e.g., Evolved Packet System (EPS)).

### BACKGROUND

Internet Protocol (IP) Multimedia Subsystem (IMS) based emergency calls in the Third Generation Partnership Project (3GPP) Fifth Generation (5G) Core (5GC) with Service Request triggered Evolved Packet System (EPS) fallback is specified in 3GPP Technical Specification (TS) 23.502 V15.4.0 § 4.13.4.2 and 3GPP TS 23.501 V15.4.0, § 5.16.4.11. FIG. 14.13.4.2-1 from 3GPP TS 23.502 is reproduced as FIG. 1. The details of the procedure illustrated in FIG. 14.13.4.2-1 are included in 3GPP TS 23.502 and, as such, are not repeated here.

The User Equipment (UE) is registered in the 5GC and, when the respective user dials an emergency number, the UE will perform a Service Request (step 3 of FIG. 1) indicating emergency fallback. The network will then either perform Inter-Radio Access Technology (IRAT) handover or perform a release with redirect to move the UE to EPS. Note that IRAT fallback is also possible either using redirect or handover. The UE on EPS would set up an emergency Packet Data Network (PDN) session and perform IMS emergency call procedures per legacy Voice over Long Term Evolution (VoLTE) scenarios.

In regard to step 5b of FIG. 1 and if a redirect method is used, the UE on EPS would perform a Tracking Area Update (TAU) procedure which is specified in 3GPP TS 23.502 V15.4.0, § 4.11.1.3.2.

In regard to step 5b of FIG. 1 and if an IRAT inter-system Handover (HO) method is used, the network procedure for IRAT inter-system HO is specified in 3GPP TS 23.502 V15.4.0, § 4.11.1.2.1. After step 5b in FIG. 1 (step 7034 in FIG. 7B described below), the UE would start an emergency call procedure in Long Term Evolution (LTE)/Evolved Packet Core (EPC).

There currently exist certain challenge(s) with IMS based emergency calls in the 5GC with Service Request triggered EPS fallback that may result in undesired results. Systems and methods for addressing at least some of these challenges are described herein.

### SUMMARY

Systems and methods are disclosed for service request triggered fallback for an emergency service in a cellular communications system. Embodiments of a method performed by a wireless device for redirecting from a first wireless communication system using a first radio access type to a second wireless communication system using a second radio access type after having performed a service request in the first wireless communication system for an emergency call are also disclosed. In some embodiments, the method comprises transmitting a connection request message to a base station in the second wireless communication system as part of a connection establishment procedure whereby the wireless device establishes a connection to the second wireless communication system, the connection request message comprising an indication that a cause of connection establishment is an emergency. In this manner, the base station can provide emergency treatment for the connection request.

In some embodiments, the method further comprises transmitting a tracking area update request to the base station and receiving a tracking area update accept message from the base station.

In some embodiments, the connection request message is a Radio Resource Control (RRC) Connection Request.

In some embodiments, the first wireless communication system is a Fifth Generation (5G) System (5GS), and the second wireless communication system is an Evolved Packet System (EPS).

Corresponding embodiments of a wireless device for redirecting from a first wireless communication system using a first radio access type to a second wireless communication system using a second radio access type after having performed a service request in the first wireless communication system for an emergency call are disclosed. In some embodiments, the wireless device is adapted to transmit a connection request message to a base station in the second wireless communication system as part of a connection establishment procedure whereby the wireless device establishes a connection to the second wireless communication system, the connection request message comprising an indication that a cause of connection establishment is an emergency. In some embodiments, the wireless device comprises one or more transmitters and processing circuitry associated with the one or more transmitters, where the processing circuitry is configured to cause the wireless device to transmit the connection request message to the base station in the second wireless communication system as part of the connection establishment procedure whereby the wireless device establishes a connection to the second wireless communication system, the connection request message comprising the indication that the cause of connection establishment is an emergency.

Embodiments of a method performed by a network node for redirecting a wireless device from a first wireless communication system using a first radio access type to a second wireless communication system using a second radio access type after the wireless device having performed a service request in the first wireless communication system for an emergency call are also disclosed. The network node is in the second wireless communication system. The method comprises receiving a connection request message from the wireless device as part of a connection establishment procedure whereby a connection between the wireless device and the second wireless communication system is established, the connection request message comprising an indication that a cause of connection establishment is an emergency.

In some embodiments, the method further comprises receiving a tracking area update request from the wireless device as part of a tracking area update procedure and sending a message to a second network node as part of the tracking area update procedure. The message sent to the second network node comprises an emergency indication. In some embodiments, the network node is a base station and the second network node is a core network node.

In some embodiments, the first wireless communication system is a 5GS, the second wireless communication system is an EPS, the network node is an enhanced or evolved Node B (eNB), and the second network node is a Mobility Management Entity (MME).

In some embodiments, the method further comprises receiving, from the second network node in association with a tracking area update accept, a message comprising an emergency fallback indication.

In some embodiments, the connection request message is an RRC Connection Request.

In some embodiments, as a result of the indication, the network node gives the wireless device emergency treatment.

Corresponding embodiments of a network node for redirecting a wireless device from a first wireless communication system using a first radio access type to a second wireless communication system using a second radio access type after the wireless device having performed a service request in the first wireless communication system for an emergency call, wherein the network node is in the second wireless communication system, are also disclosed. In some embodiments, the network node is adapted to receive a connection request message from the wireless device as part of a connection establishment procedure whereby a connection between the wireless device and the second wireless communication system is established, the connection request message comprising an indication that a cause of connection establishment is an emergency. In some embodiments, the network node comprises processing circuitry configured to cause the network node to receive the connection request message from the wireless device as part of the connection establishment procedure.

Embodiments of a method performed by a network node for redirecting a wireless device from a first wireless communication system using a first radio access type to a second wireless communication system using a second radio access type after the wireless device having performed a service request in the first wireless communication system for an emergency call, wherein the network node is in the second wireless communication system, are also disclosed. In some embodiments, the method comprises receiving a tracking area update request from a base station in the second wireless communication system as part of a tracking area update procedure and sending, to a second network node in the first wireless communication system, a context request message as part of the tracking area update procedure. The method further comprises receiving, from the second network node, a context request response message comprising an emergency fallback indicator and sending, to the base station in association with a tracking area update accept, a message comprising an emergency fallback indicator.

In some embodiments, the network node is an MME. In some embodiments, the second network node is an Access and Mobility Management Function (AMF).

Corresponding embodiments of a network node for redirecting a wireless device from a first wireless communication system using a first radio access type to a second wireless communication system using a second radio access type after the wireless device having performed a service request in the first wireless communication system for an emergency call, wherein the network node is in the second wireless communication system, are also disclosed. In some embodiments, the network node is adapted to receive a tracking area update request from a base station in the second wireless communication system as part of a tracking area update procedure and send, to a second network node in the first wireless communication system, a context request message as part of the tracking area update procedure. The network node is further adapted to receive, from the second network node, a context request response message comprising an emergency fallback indicator and send, to the base station in association with a tracking area update accept, a message comprising an emergency fallback indicator. In some embodiments, the network node comprises processing circuitry configured to cause the network node to receive the tracking area update request from the base station, send the context request message to the second network node, receive the context request response message from the second network node, and send, in association with the tracking area update accept, the message to the base station.

Embodiments of a network node for redirecting a wireless device from a first wireless communication system using a first radio access type to a second wireless communication system using a second radio access type after the wireless device having performed a service request in the first wireless communication system for an emergency call, wherein the network node is in the first wireless communication system, are also disclosed. In some embodiments, the method comprises receiving, from a second network node in the second wireless communication system, a context request message as part of a tracking area update procedure for the wireless device and sending, to the second network node, a context request response message comprising an emergency fallback indicator.

In some embodiments, the network node is an AMF. In some embodiments, the second network node is an MME.

Corresponding embodiments of a network node for redirecting a wireless device from a first wireless communication system using a first radio access type to a second wireless communication system using a second radio access type after the wireless device having performed a service request in the first wireless communication system for an emergency call, wherein the network node is in the first wireless communication system, are also disclosed. In some embodiments, the network node is adapted to receive, from a second network node in the second wireless communication system, a context request message as part of a tracking area update procedure for the wireless device and send, to the second network node, a context request response message comprising an emergency fallback indicator. In some embodiments, the network node comprises processing circuitry configured to cause the network node to receive the context request message from the second network node and send the context request response message to the second network node.

Embodiments of a method performed by a system for redirecting a wireless device from a first wireless communication system using a first radio access type to a second wireless communication system using a second radio access type after the wireless device having performed a service request in the first wireless communication system for an emergency call are also disclosed. In some embodiments, the method comprises, at the wireless device, transmitting a connection request message to a base station in the second wireless communication system as part of a connection establishment procedure whereby the wireless device establishes a connection to the second wireless communication system, the connection request message comprising an indication that a cause of connection establishment is an emergency. The method further comprises, at the base station, receiving the connection request message from the wireless device as part of the connection establishment procedure, receiving a tracking area update request from the wireless device during a tracking area update procedure, sending the tracking area update request to a first network node, and sending a message to the first network node as part of the tracking area update procedure, wherein the message sent to the first network node comprises an emergency indication and the first network node is part of the second wireless communication system. The method further comprises, at the first network node, receiving the tracking area update request and the message comprising the emergency indication from the base station as part of the tracking area update procedure, sending, to a second network node in the first wireless communication system, a context request message as part of the tracking area update procedure, receiving, from the second network node, a context request response message comprising an emergency fallback indicator, and sending, to the base station in association with a tracking area update accept, a message comprising an emergency fallback indicator. The method further comprises, at the second network node, receiving the context request message from the first network node and sending the context request response message comprising the emergency fallback indicator to the first network node.

Embodiments of method of operation of a network node during an Inter-Radio Access Technology (IRAT) handover procedure performed for handover of a wireless device from a first wireless communication system using a first radio access type to a second wireless communication system using a second radio access type after the wireless device having performed a service request in the first wireless communication system for an emergency call, wherein the network node is in the first wireless communication system, are also disclosed. In some embodiments, the method comprises sending, to a second network node in the first wireless communication system, a handover required message for the wireless device, wherein the handover required message comprises a transparent source-to-target container that comprises an emergency indicator.

In some embodiments, the network node is a base station in the first wireless communication system. In some embodiments, the second network node is an AMF in the first wireless communication system.

In some embodiments, the first wireless communication system is a 5GS, and the second wireless communication system is an EPS.

Corresponding embodiments of a network node for an IRAT handover procedure performed for handover of a wireless device from a first wireless communication system using a first radio access type to a second wireless communication system using a second radio access type after the wireless device having performed a service request in the first wireless communication system for an emergency call, wherein the network node is in the first wireless communication system, are also disclosed. In some embodiments, the network node is adapted to send, to a second network node in the first wireless communication system, a handover required message for the wireless device, wherein the handover required message comprises a transparent source-to-target container that comprises an emergency indicator. In some embodiments, the network node comprises processing circuitry configured to cause the network node to send the handover required message to the second network node.

Embodiments of a method performed by a network node during an IRAT handover procedure performed for handover of a wireless device from a first wireless communication system using a first radio access type to a second wireless communication system using a second radio access type after the wireless device having performed a service request in the first wireless communication system for an emergency call, wherein the network node is in the first wireless communication system, are also disclosed. In some embodiments, the method comprises sending, to a second network node in the second wireless communication system during the IRAT handover procedure, a forward location request, the forward location request comprising an emergency fallback indicator.

In some embodiments, the method further comprises, prior to sending the forward location request to the second network node, receiving, from a base station in the first wireless communication system, a message comprising a transparent source to target container associated with the IRAT handover procedure, wherein the transparent source to target container comprises an emergency fallback indicator. In some embodiments, sending the forward location request comprising the emergency indication to the second network node comprises sending the forward location request comprising the transparent source to target container such that the emergency fallback indication comprised in the forward location request is the emergency fallback indication comprised in the transparent source to target container.

In some embodiments, the method further comprises, prior to sending the forward location request to the second network node, receiving, from a base station in the first wireless communication system, a message comprising a transparent source to target container associated with the IRAT handover procedure. In some embodiments, the forward location request sent to the second network node comprises the transparent source to target container, and the emergency fallback indicator comprised in the forward location request is separate from the transparent source to target container. In some embodiments, the transparent source to target container comprises an emergency fallback indicator.

In some embodiments, the second network node is an MME. In some embodiments, the network node is an AMF.

Corresponding embodiments of a network node for an IRAT handover procedure performed for handover of a wireless device from a first wireless communication system using a first radio access type to a second wireless communication system using a second radio access type after the wireless device having performed a service request in the first wireless communication system for an emergency call, wherein the network node is in the first wireless communication system, are disclosed. In some embodiments, the network node is adapted to send, to a second network node in the second wireless communication system during the IRAT handover procedure, a forward location request, wherein the forward location request comprises an emergency fallback indicator. In some embodiments, the network node comprises processing circuitry configured to cause the network node to send the forward location request to the second network node.

Embodiments of a method performed by a first network node during an IRAT handover procedure performed for handover of a wireless device from a first wireless communication system using a first radio access type to a second wireless communication system using a second radio access type after the wireless device having performed a service request in the first wireless communication system for an emergency call, wherein the first network node is in the second wireless communication system, are also disclosed. In some embodiments, the method comprises sending, to a base station in the second wireless communication system during the IRAT handover procedure, a handover request comprising an emergency fallback indicator.

In some embodiments, the first network node is an MME.

In some embodiments, the method further comprises, prior to sending the handover request, receiving, from a second network node in the first wireless communication system during the IRAT handover procedure, a forward location request, the forward location request comprising an emergency fallback indicator.

Embodiments of a first network node for an IRAT handover procedure performed for handover of a wireless device from a first wireless communication system using a first radio access type to a second wireless communication system using a second radio access type after the wireless device having performed a service request in the first wireless communication system for an emergency call, wherein the first network node is in the second wireless communication system, are also disclosed. In some embodiments, the first network node is adapted to send, to a base station in the second wireless communication system during the IRAT handover procedure, a handover request comprising an emergency fallback indicator. In some embodiments, the first network node comprises processing circuitry configured to cause the first network node to send the handover request to the base station.

Embodiments of a method performed by a base station during an IRAT handover procedure performed for handover of a wireless device from a first wireless communication system using a first radio access type to a second wireless communication system using a second radio access type after the wireless device having performed a service request in the first wireless communication system for an emergency call, wherein the base station is in the second wireless communication system, are also disclosed. In some embodiments, the method comprises sending, to a core network node in the second wireless communication system during the IRAT handover procedure, a handover request acknowledgement comprising an emergency fallback indicator.

In some embodiments, the method further comprises, prior to sending the handover request acknowledgment, receiving, from the core network node, a message comprising a source to target transparent container, the source to target transparent container comprising an emergency fallback indicator.

Corresponding embodiments of a base station for an IRAT handover procedure performed for handover of a wireless device from a first wireless communication system using a first radio access type to a second wireless communication system using a second radio access type after the wireless device having performed a service request in the first wireless communication system for an emergency call, wherein the base station is in the second wireless communication system, are also disclosed. In some embodiments, the base station is adapted to send, to a core network node in the second wireless communication system during the IRAT handover procedure, a handover request acknowledgement comprising an emergency fallback indicator. In some embodiments, the base station comprises processing circuitry configured to cause the base station to send the handover request acknowledgement to the core network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 14.13.4.2-1 from Third Generation Partnership Project (3GPP) Technical Specification (TS) 23.502 V15.4.0;

FIG. 2 illustrates one example of a system, including two wireless communications systems (namely, in this example, a Fifth Generation (5G) System (5GS) and a Evolved Packet System (EPS)), in which embodiments of the present disclosure may be implemented;

FIGS. 3 and 4 are different representations of a particular implementation of the 5GS components of the system of FIG. 2;

FIG. 5 illustrates a particular implementation of the EPS components of the system of FIG. 2;

FIGS. 6A and 6B illustrate the operation of the system of FIGS. 2 through 5 to provide an emergency indication during service requested fallback for emergency services for a wireless device via redirection from the 5GS to the EPS in accordance with some embodiments of the present disclosure;

FIGS. 7A and 7B illustrate the operation of the system of FIGS. 2 through 5 to provide an emergency indication during service requested fallback for a wireless device via an Inter-Radio Access Technology (IRAT) handover from the 5GS to the EPS in accordance with some embodiments of the present disclosure;

FIGS. 8 through 10 are schematic block diagrams of example embodiments of a network node; and

FIGS. 11 and 12 are schematic block diagrams of example embodiments of a wireless device.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include core network nodes in an Evolved Packet Core (EPC) such as, e.g., a Mobility Management Entity (MME), a Packet Data Network Gateway (P-GW), a Service Capability Exposure Function (SCEF), or the like and core network nodes or functions in a 5G Core (5GC) such as, e.g., an Access and Mobility Management Function (AMF), a Session Management Function (SMF), a Policy Control Function (PCF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

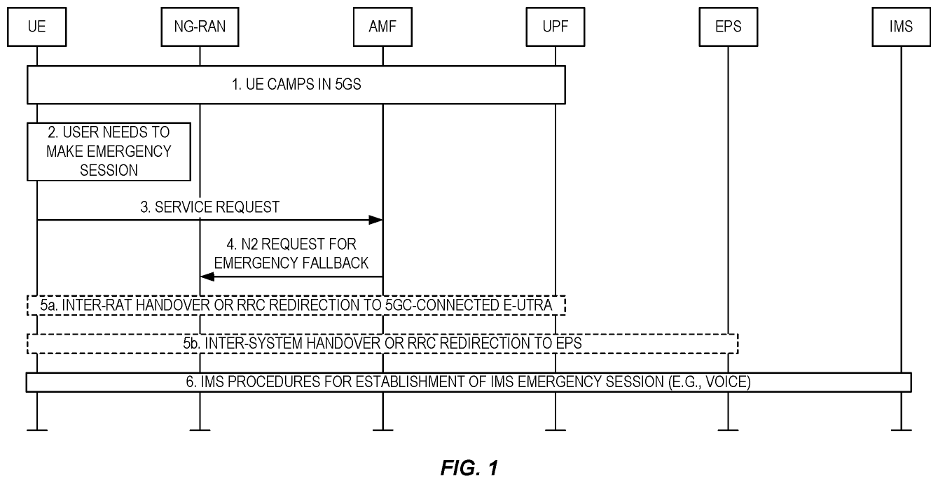

There currently exist certain challenge(s) with Internet Protocol (IP) Multimedia Subsystem (IMS) based emergency calls in the 3GPP 5GC with Service Request triggered Evolved Packet System (EPS) fallback. First, in regard to step 5b of the conventional process illustrated in FIG. 1, if the redirect method is used, the UE in LTE/EPC performing the Tracking Area Update (TAU) has no emergency session yet, but the UE should still be treated with emergency call treatment (i.e., as an emergency call or emergency case). Otherwise, an eNB or MME without such information may treat the mobility procedure normally, thereby risking rejection of the attempt (e.g., access/mobility restriction), delay of the call setup as the MME may need to redirect the UE to another MME if Dedicated Core (DECOR) is deployed in the network, or even the UE may be sent back to a 5G RAN by LTE. The UE will start with emergency Packet Data Network (PDN) session setup soon in the EPS after the TAU procedure.

Second, in regard to step 5b of FIG. 1, if the Inter-Radio Access Technology (IRAT) Handover (HO) method is used, as the UE does not have an emergency session and without knowledge in the network that the mobility procedures are related to following emergency session setup, there is a risk that the eNB or MME will reject the attempt (e.g., access/mobility restriction), delay the call setup as the MME may need to redirect the UE to another MME if DECOR is deployed in the network, or even send the UE back to the 5G RAN by LTE.

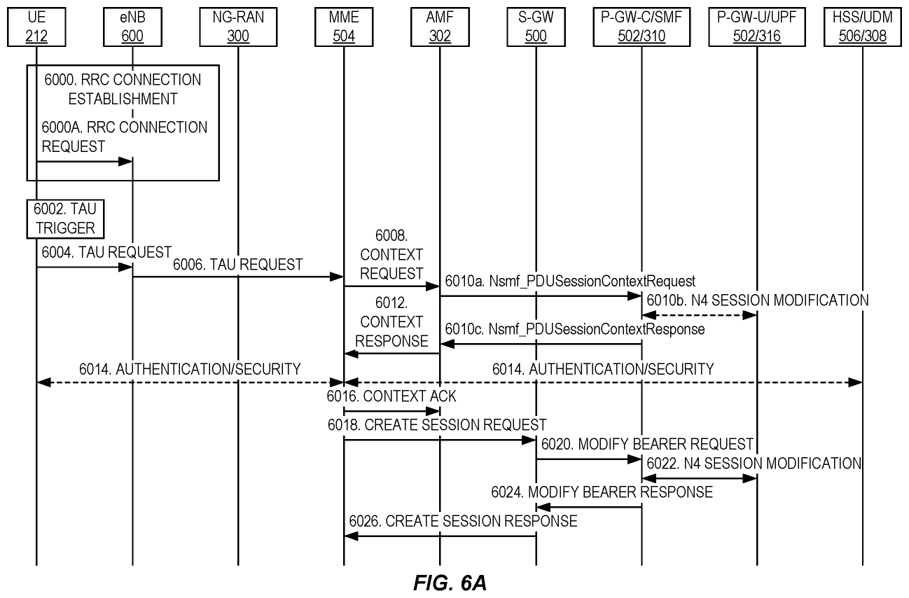

Certain aspects of the present disclosure and their embodiments may provide solutions to the aforementioned or other challenges. First embodiments are disclosed that relate to step 5b of FIG. 1 when the redirect method is used. In some aspects of the first embodiments, a UE that moves to EPS with a release procedure after having performed a Service Request procedure in the 5G System (5GS) for an emergency call uses an emergency indication in the Radio Resource Control (RRC) connection Request as part of establishment cause (see, e.g., 3GPP Technical Specification (TS) 36.331 § 6.2.2), as described below with respect to step 6000A of FIG. 6A. The addition of this new emergency indication as a possible establishment cause in the RRC connection Request can be written in standards language as:
RRC Establishment cause in 36.331 § 6.2.2 RRC Connection Request
establishmentCause
Provides the establishment cause for the RRC connection request as provided by the upper layers. With respect to the cause value names: highPriorityAccess concerns AC11 . . . AC15, ‘mt’ stands for ‘Mobile Terminating’ and ‘mo’ for ‘Mobile Originating’. eNB is not expected to reject a RRCConnectionRequest due to unknown cause value being used by the UE.

| | |
|---|---|
| EstablishmentCause::= | ENUMERATED{ |
| | emergency, highPriorityAccess, mt- |

Access, mo-Signalling, mo-Data, delayTolerantAccess-v1020, mo-
VoiceCall-v1280, spare1}

The inclusion of the emergency indication in the RRC Connection Request when establishing the RRC connection prior to a TAU would enable the eNB to give the UE emergency treatment even though the UE is still not in any emergency session (no emergency PDN in network).

At the next step, the UE would perform TAU toward the MME, as described below with respect to step 6004 in FIG. 6A. The eNB, after receiving the TAU request from the UE, includes the emergency indicator in the initial UE message (see, e.g., 3GPP TS 36.413) sent to the MME using “RRC establishment cause=emergency.” This is steps 6004 and 6006 of FIG. 6A described below. The establishment cause is used in the S1-AP, 3GPP TS 36.413 § 9.2.1.3a RRC Establishment Cause. Based on this, the eNB can enforce “no return to 5G” functionality in the eNB, avoiding a scenario in which the UE is sent back to 5G when emergency call is not supported in 5G.

After the TAU triggering and the TAU request (see steps 6004 and 6006 in FIG. 6A described below), both the eNB and the MME know the emergency case and should not reject the UE (i.e., the eNB and the MME do not reject the UE in this scenario). The following steps can be used to inform the network that it is an emergency fallback case.
The MME gets the TAU and requests context from the AMF (see step 6008 in FIG. 6A described below).
In the Context Response (see step 6012 in FIG. 6A described below), the AMF indicates ‘emergency fallback’.
The MME in the Initial Context Setup message provides the eNB with the ‘emergency fallback’ indicator (in relation to step 6034 in FIG. 6B described below).
After this step, both the MME and the eNB know the emergency fallback case, and the eNB can prevent initiation of a HO to 5GS as well as release with redirect to 5GS, at least as long as the emergency call is ongoing.
Based on this, the eNB can enforce “no return to 5G” functionality in the eNB, avoiding a scenario in which the UE is sent back to 5G when there is a mix of emergency call allowed and not allowed in 5G.

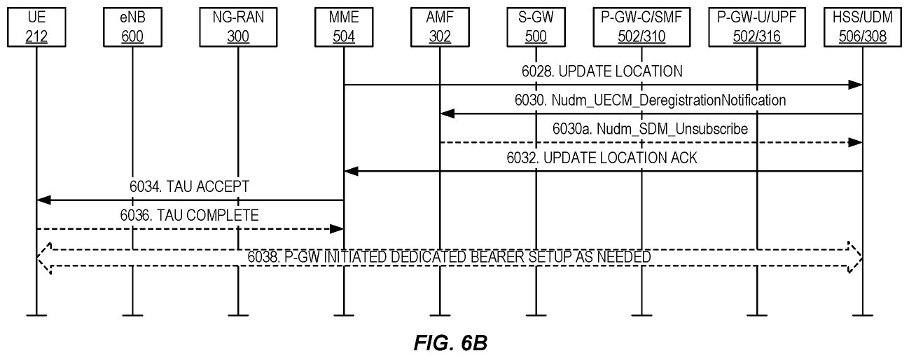

Second embodiments are disclosed that relate to step 5b of FIG. 1 when the IRAT HO method is used. A number of alternatives of the second embodiments are as follows:
Alternative 1: When a UE moves to EPS with the IRAT HO procedure after having performed a Service Request procedure in 5GS for emergency call, the NR network sends, in a source to target transparent container toward the eNB, an indication that the procedure is related to “emergency call with EPS fallback with service request.” The source to target transparent container is an information element that is constructed by the source RAN node and sent to the target RAN node and filled by the target RAN node and sent back to the source RAN node during IRAT HO. Note that when it is sent back to the source RAN, it can be called a target to source transparent container. While the 3GPP standards already include the possibility that the container contains an emergency indicator, neither the AMF nor the MME read this container (i.e., the container is transparent for them). Hence, in some embodiments, an emergency fallback indicator is added by the AMF for the MME into the Forward Relocation Request. The MME then has the Emergency Fallback indicator and also carries the “source to target transparent container” from the AMF to the MME. In other words, in some embodiments, since the AMF in the 5GC during Service Request procedure is aware of the emergency call procedure and even that it is an emergency fallback, the AMF includes an emergency fallback indicator in the Forward Relocation Request (see step 7006 in the call flow of FIG. 7A described below, Relocation Request—Note that in TS 29.274 this message is called “Forward relocation Request”) toward the MME to enable the MME to treat the mobility procedure with emergency priority. This is despite that there is no emergency PDN yet. The forward relocation request is further specified in 3GPP TS 29.274.
Alternative 2 (without emergency indication in the source to target transparent container or in addition to the source to target transport container including the emergency indication): The MME, as a consequence of receiving an emergency fallback indicator in the Forward Relocation Request (see step 7006 in the call flow of FIG. 7A), includes an emergency fallback indicator to the eNB in the Handover Request message (see step 7012 in the call flow of FIG. 7A).
Alternative 3 (without indication in Forward Relocation Request): The eNB, as a consequence of receiving an emergency fallback indicator in the source to target transparent container, includes an emergency fallback indicator to the MME in the Handover Request Acknowledgement (ACK) message (see step 7014 in the call flow of FIG. 7A).

Certain embodiments may provide one or more of the following technical advantage(s). Possible benefits of the first embodiments include, but are not limited to, the following. The first embodiments may enable the network to treat the UE with proper emergency treatment, both in LTE RAN and also in EPC. The first embodiments may lower the risk for delayed call setup of emergency calls.

Possible benefits of the second embodiments include, but are not limited to the following. The second embodiments may enable the network to treat the UE with proper emergency treatment, both in LTE RAN and also in EPC. The second embodiments may lower the risk for delayed call setup of emergency calls. The second embodiments may remove the risk of the UE being rejected due to, e.g., access/mobility restriction.

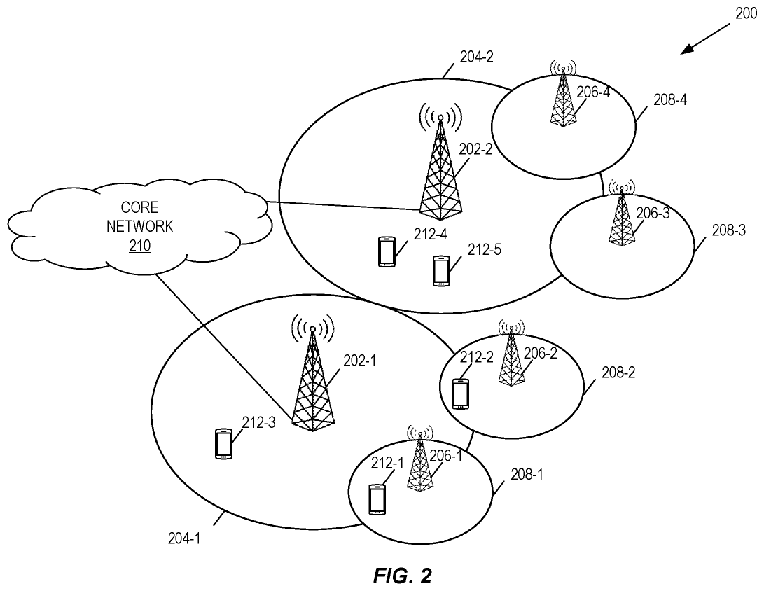

FIG. 2 illustrates one example of a system 200 in which embodiments of the present disclosure may be implemented. In the embodiments described herein, the system 200 is a 3GPP system that may include both Fourth Generation (4G) (e.g., LTE/EPS) and 5G (i.e., NR/5GS) networks. In this example, the cellular communications system 200 includes base stations 202-1 and 202-2, which in LTE are referred to as eNBs and in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The cellular communications network 200 may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 (and optionally the low power nodes 206) are connected to a core network(s) 210. Note that, for 5G base stations (also referred to herein as Next Generation RAN (NG-RAN) nodes), these base stations are connected to a 5GC (but may also be connected to an EPC in the case of Evolved Universal Terrestrial Radio Access (E-UTRA) NR Dual Connectivity (EN-DC)), whereas LTE base stations are connected to an EPC, as will be appreciated by one of ordinary skill in the art. Thus, the core network(s) 210 include, in the example embodiments described herein, a 5GC to which some of the base stations 202 (i.e., base stations 202 in the 5G RAN or NG-RAN) are connected and an EPC to which some others of the base stations 202 (i.e., base stations 202 in the LTE RAN or E-UTRA Network (E-UTRAN)) are connected.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs.

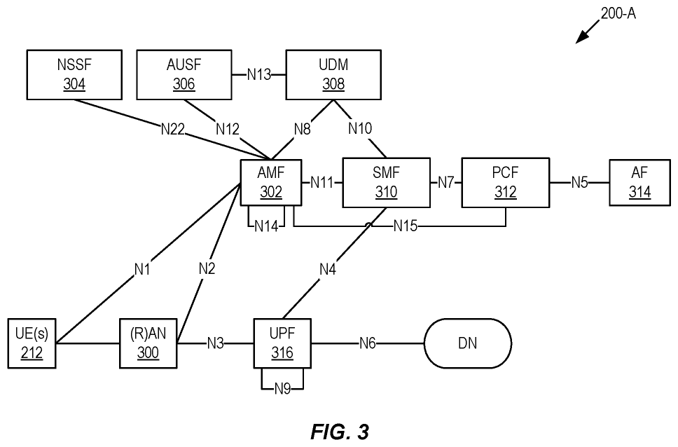

FIG. 3 illustrates a 5G network architecture composed of core Network Functions (NFs), where interaction between any two NFs is represented by a point-to-point reference point/interface. FIG. 3 can be viewed as one particular implementation of the 5G components of the system 200 of FIG. 2 and is referenced as system 200-A.

Seen from the access side the 5G network architecture shown in FIG. 3 comprises a plurality of UEs 212 connected to either a RAN or an Access Network (AN) 300 as well as an AMF 302. Typically, the (R)AN 300 comprises base stations, e.g. such as eNBs or gNBs or similar. Seen from the core network side, the 5G core NFs shown in FIG. 3 include a Network Slice Selection Function (NSSF) 304, an Authentication Server Function (AUSF) 306, a Unified Data Management (UDM) 308, an AMF 302, a SMF 310, a PCF 312, an Application Function (AF) 314, and a User Plane Function (UPF) 316.

Reference point representations of the 5G network architecture are used to develop detailed call flows in the normative standardization. The N1 reference point is defined to carry signaling between the UE 212 and AMF 302. The reference points for connecting between the AN 300 and AMF 302 and between the AN 300 and UPF 316 are defined as N2 and N3, respectively. There is a reference point, N11, between the AMF 302 and SMF 310, which implies that the SMF 310 is at least partly controlled by the AMF 302. N4 is used by the SMF 310 and UPF 316 so that the UPF 316 can be set using the control signal generated by the SMF 310, and the UPF 316 can report its state to the SMF 310. N9 is the reference point for the connection between different UPFs 316, and N14 is the reference point connecting between different AMFs 302, respectively. N15 and N7 are defined since the PCF 312 applies policy to the AMF 302 and SMF 310, respectively. N12 is required for the AMF 302 to perform authentication of the UE 212. N8 and N10 are defined because the subscription data of the UE 212 is required for the AMF 302 and SMF 310.

The 5G core network aims at separating user plane and control plane. The user plane carries user traffic while the control plane carries signaling in the network. In FIG. 3, the UPF 316 is in the user plane and all other NFs, i.e., the AMF 302, SMF 310, PCF 312, AF 314, AUSF 306, and UDM 308, are in the control plane. Separating the user and control planes guarantees each plane resource to be scaled independently. It also allows UPFs 316 to be deployed separately from control plane functions in a distributed fashion. In this architecture, UPFs 316 may be deployed very close to UEs 212 to shorten the Round Trip Time (RTT) between UEs 212 and data network for some applications requiring low latency.

The core 5G network architecture is composed of modularized functions. For example, the AMF 302 and SMF 310 are independent functions in the control plane. Separated AMF 302 and SMF 310 allow independent evolution and scaling. Other control plane functions like the PCF 312 and AUSF 306 can be separated as shown in FIG. 3. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs 316.

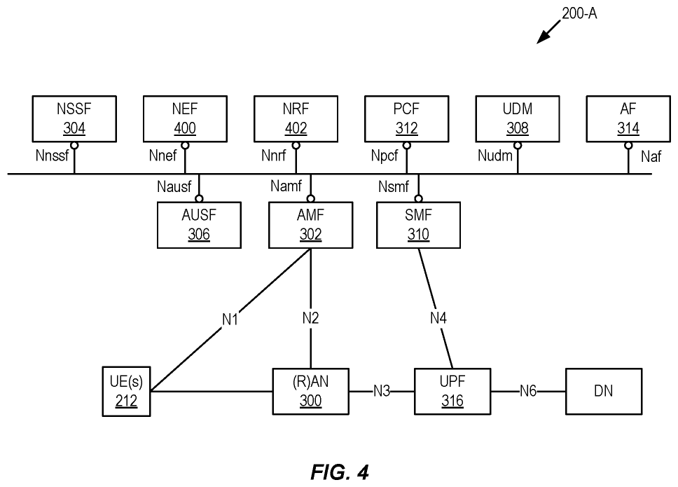

FIG. 4 illustrates a 5G network architecture using service-based interfaces between the NFs in the control plane, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF 302 and Nsmf for the service based interface of the SMF 310, etc. The Network Exposure Function (NEF) 400 and the Network Repository Function (NRF) 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 302 provides UE-based authentication, authorization, mobility management, etc. A UE 212 even using multiple access technologies is basically connected to a single AMF 302 because the AMF 302 is independent of the access technologies. The SMF 310 is responsible for session management and allocates IP addresses to UEs 212. It also selects and controls the UPF 316 for data transfer. If a UE 212 has multiple sessions, different SMFs may be allocated to each session to manage them individually and possibly provide different functionalities per session. The AF 314 provides information on the packet flow to the PCF 312 responsible for policy control in order to support Quality of Service (QoS). Based on the information, the PCF 312 determines policies about mobility and session management to make the AMF 302 and SMF 310 operate properly. The AUSF 306 supports authentication function for UEs 212 or similar and thus stores data for authentication of UEs 212 or similar while the UDM 308 stores subscription data of the UE 212. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

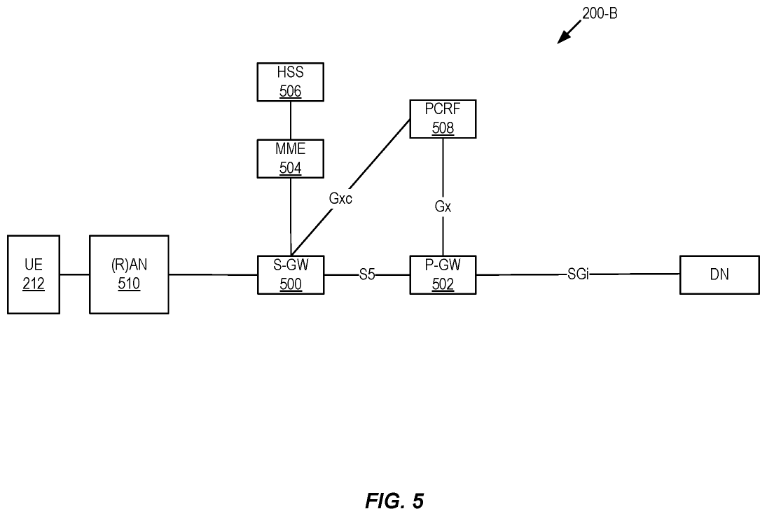

FIG. 5 illustrates an LTE network architecture. FIG. 5 can be viewed as one particular implementation of the LTE components of the system 200 of FIG. 2 and is referenced as system 200-B. As will be appreciated by one of skill in the art, the core network for LTE, which is referred to as an EPC, includes a number of core network entities such as, e.g., a Serving Gateway (S-GW) 500, a P-GW 502, an MME 504, a Home Subscriber Server (HSS) 506, and a Policy and Charging Rules Function (PCRF) 508. The operational details of the S-GW 500, the P-GW 502, the MME 504, the HSS 506, and the PCRF 508 are well known to those of skill in the art and therefore are not repeated here. A (R)AN 510 of the LTE network includes base stations such as, e.g., eNBs.

FIGS. 6A and 6B illustrate a TAU procedure in accordance with first embodiments of the present disclosure. In particular, this process of FIGS. 6A and 6B relates to step 5b of FIG. 1 when the redirect method is used. In some aspects of the first embodiments, a UE 212 that moves to EPS with a release procedure after having performed a Service Request procedure in 5GS for an emergency call uses an emergency indication in an RRC Connection Request (step 6000A) during an RRC Connection Establishment procedure when establishing an RRC connection prior to a TAU (step 6000). As illustrated, the UE 212 sends the RRC connection request to a base station 212 in the LTE RAN (also referred to as an E-UTRAN, which is shown as an eNB and referenced here as eNB 600. The details of the RRC Connection Establishment procedure are well known to those of skill in the art and, as such, are not repeated here. The emergency indication is included in the RRC Connection Request as part of establishment cause (3GPP T536.331 § 6.2.2). The addition of this new emergency indication as a possible establishment cause in the RRC Connection Request can be written as:
RRC Establishment cause in 36.331 § 6.2.2 RRC Connection Request
establishmentCause
Provides the establishment cause for the RRC connection request as provided by the upper layers. With respect to the cause value names: highPriorityAccess concerns AC11 . . . AC15, ‘mt’ stands for ‘Mobile Terminating’ and ‘mo’ for ‘Mobile Originating’. eNB is not expected to reject a RRCConnectionRequest due to unknown cause value being used by the UE.

| | |
|---|---|
| EstablishmentCause::= | ENUMERATED{ |
| | emergency, highPriorityAccess, mt- |

Access, mo-Signalling, mo-Data, delayTolerantAccess-v1020, mo-
VoiceCall-v1280, spare1}

The inclusion of the emergency indication in the RRC Connection Request when establishing the RRC connection prior to the TAU enables the eNB 600 to give the UE 212 emergency treatment even though the UE 212 is still not in any emergency session (no emergency PDN in network).

A TAU procedure is then performed. The example of FIGS. 6A and 6B uses a modified version of the existing TAU procedure but includes new aspects relating to communicating and using the emergency indicator received from the UE 212 in the RRC Connection Request. However, the first embodiments are not limited thereto. The first embodiments are equally applicable to other variations of the TAU procedure. The existing TAU procedure is defined in 3GPP TS 23.502 V15.4.0 § 4.11.1.3.2, as will be appreciated by one of ordinary skill in the art. Since the TAU procedure is well known, the following description focuses on the new aspects of the modified version of the TAU procedure.

In general, the emergency indication is communicated from the eNB 600 to the MME 504 during the TAU procedure. Then, based on the emergency indication, both the eNB 600 and the MME 504 know to give the UE 212 emergency treatment (e.g., do not reject the attempt to redirect the UE 212 to the EPC, do not redirect the UE 212 to another MME thereby avoiding the risk of call setup delay, and do not send the UE 212 back to 5G).

As illustrated, the TAU is triggered at the UE 212 (step 6002), and the UE 212 then performs a TAU toward the MME 504 by sending a TAU request to the MME 504, which is communicated to the MME 504 via the eNB 600 (step 6004). After receiving the TAU request from the UE 212, the eNB 600 includes an emergency indicator in an Initial UE message (see, e.g., 3GPP TS 36.413) sent to the MME 504 (e.g., in association with the TAU request) with the RRC establishment cause set to an indication of emergency (e.g., using “RRC establishment cause=emergency”) (step 6006). The establishment cause is used in the S1-AP, 3GPP TS 36.413 § 9.2.1.3a RRC Establishment Cause. Based on this, the eNB 600 can enforce “no return to 5G” functionality in the eNB 600, thereby avoiding a scenario in which the UE 212 is sent back to 5G when emergency call is not supported in 5G.

After steps 6004 and 6006, both the eNB 600 and the MME 504 know the emergency case and do not reject the UE 212. In some embodiments, the following steps can be used to inform the network that it is an emergency fallback case.
The MME 504 gets the TAU request and requests context from the AMF 302 (step 6008). The AMF 302 sends an Nsmf_PDUSessionContextRequest message to the P-GW 502/SMF 310 (step 6010a), which returns a Nsmf_PDUSessionContextResponse message back to the AMF 302 (step 6010c). The AMF 302 returns a Context Response to the MME 504 (step 6012).
In the Context Response (step 6012), the AMF 302 indicates “emergency fallback.” The TAU procedure then continues in the conventional manner (steps 6014 through 6032).
The MME 504, in an Initial Context Setup message associated with the TAU Accept sent from the MME 504 to the UE 212 via the eNB 600, provides the eNB 600 with the emergency fallback indicator (in relation to step 6034). Note that the Initial Context Setup message is not shown in the figure, but is needed to send the TAU accept to the UE 212. After this step, both the MME 504 and the eNB 600 know the emergency fallback case, and the eNB 600 can prevent to initiate handover to 5GS. Based on this, the eNB 600 can enforce “no return to 5G” functionality in the eNB 600, avoiding a scenario in which the UE 212 is sent back to 5G when there is a mix of emergency call allowed and not allowed in 5G.
The TAU procedure then continues in the conventional manner (steps 6036 through 6038).

FIGS. 7A and 7B illustrate a call flow for second embodiments of the present disclosure. The second embodiments relate to step 5b of FIG. 1 when the IRAT HO method is used. In general, FIGS. 7A and 7B illustrate an IRAT HO procedure, which is similar to the existing IRAT HO procedure defined in 3GPP TS 23.502 V15.4.0 § 4.11.1.2.1. The second embodiments are described with respect to this IRAT HO procedure and, as such, the following description focuses on the new aspects introduced by the second embodiments of the present disclosure. Note, however, that the IRAT HO procedure of FIGS. 7A and 7B is only an example. The second embodiments are equally applicable to other variations of the IRAT HO procedure.

A number of alternatives of the second embodiments are as follows:
Alternative 1: When a UE 212 moves to EPS with IRAT HO procedure after having performed a Service Request procedure in 5GS for an emergency call, the NR network (i.e., the NG-RAN 300) sends, in a source to target transparent container toward the eNB (i.e., the target eNB in the LTE RAN 510, which is also referred to as E-UTRAN 510), an indication that the procedure is related to “emergency call with EPS fallback with service request.” In some embodiments, the source to target transparent container is an information element that is constructed by the source RAN node (i.e., the source base station in the NG-RAN 300) and sent to the target RAN node (i.e., the target eNB in the LTE RAN 510) and filled by the target RAN node and sent back to the source RAN node during IRAT HO (at which point the container is referred to as a target to source transparent container). While the 3GPP standards already include the possibility that the container contains an emergency indicator, neither the AMF 302 nor the MME 504 reads this container (i.e., the container is transparent for them). Hence, in some embodiments, an emergency fallback indicator is added by the AMF 302 for the MME 504 into the Forward Relocation Request (step 7006). The MME 504 then has the Emergency Fallback indicator. The Forward Relocation Request therefore carries the Emergency Fallback indicator from the AMF 302 to the MME 504. The Forward Relocation Request also carries the “source to target transparent container” from the AMF 302 to the MME 504. In other words, in some embodiments, since the AMF 302 in the 5GC during the Service Request procedure is aware of the emergency call procedure and even that is emergency fallback, the AMF 302 includes an Emergency Fallback indicator in the Forward Relocation Request (step 7006) toward the MME 504 to enable the MME 504 to treat the mobility procedure with emergency priority. This is despite that there is no Emergency PDN yet. With respect to this Relocation Request of step 7006, note that in TS 29.274 this message is called “Forward relocation Request”. The forward relocation request is further specified in 3GPP TS 29.274.
Alternative 2 (without emergency indication in the source to target transparent container or in addition to the source to target transport container including the emergency indication): The MME 504, as a consequence of receiving an Emergency Fallback indicator in the Forward Relocation Request in step 7006, includes an Emergency Fallback indicator to the eNB (i.e., the target RAN node in the E-UTRAN 510) in the Handover Request message (step 7012).
Alternative 3 (without indication in Forward Relocation Request): The eNB (i.e., the target RAN node in the E-UTRAN 510), as a consequence of receiving an Emergency Fallback indicator in the source to target transparent container, includes an Emergency Fallback indicator to the MME 504 in the Handover Request ACK message (step 7014).

Based on the emergency indication, the network node(s) (e.g., the eNB (i.e., the target RAN node in the E-UTRAN 510) and the MME 504) know to give the UE 212 emergency treatment (e.g., do not reject the IRAT HO attempt and do not redirect the UE 212 to another MME thereby avoiding the risk of call setup delay, and do not send the UE 212 back to 5G).

Now, a brief overview of the entire IRAT HO process of FIGS. 7A and 7B is provided. As illustrated, a Protocol Data Unit (PDU) session and QoS flow(s) are set up for the UE 212 in the 5GS (step 7000). At some point, the source RAN node in the NG-RAN 300 sends a Handover Required message to the AMF 302 (step 7002). As discussed above, the source RAN node in the NG-RAN 300 includes, in the Handover Required message, a source to target transparent container that includes an Emergency Fallback indicator. The AMF 302 obtains the UE context (steps 7004a-7004c) and sends a Relocation Request to the MME 504 (step 7006). As discussed above, in some embodiments (see Alternative 2), the Relocation Request, which is also referred to herein as a Forward Relocation Request, includes an Emergency Fallback indicator. As also discussed above, in some other embodiments (see Alternatives 1, 2 (optional), and 3), the Relocation Request also includes the source to target transparent container (received from the source RAN node in the NG-RAN 300) that includes an Emergency Fallback indicator. The MME 504 sends a Create Session Request to the S-GW 502 (step 7008) and receives a Create Session Response from the S-GW 502 (step 7010). The MME 504 sends a Handover Request to the target RAN node in the E-UTRAN 510 (step 7012). As discussed above, in some embodiments (see Alternatives 1, 2 (optional), and 3), the MME 504 includes the source to target transparent container in the Handover Request of step 7012, where the source to target transparent container includes the Emergency Fallback indicator. In some other embodiments, the MME 504 includes the Emergency Fallback indicator in the Handover Request of step 7012, with or without the Emergency Fallback indicator in the source to target transparent container (see Alternative 2). The target RAN node in the E-UTRAN 510 sends a Handover Request ACK back to the MME 504 (step 7014). As discussed above, in some embodiments (see Alternative 3), the target RAN node includes the Emergency Fallback indicator in the Handover Request ACK message sent to the MME 504. By this point, both the MME 504 and the target eNB in the E-UTRAN 510 know to give the UE 212 emergency treatment, as described above.

The IRAT HO procedure then proceeds in the conventional manner, while giving the UE 212 emergency treatment (steps 7016 through 7042b). While not needed for understanding the embodiments described herein, for additional details regarding these steps, the interested reader is directed to 3GPP TS 23.502 V15.4.0 § 4.11.1.2.1.

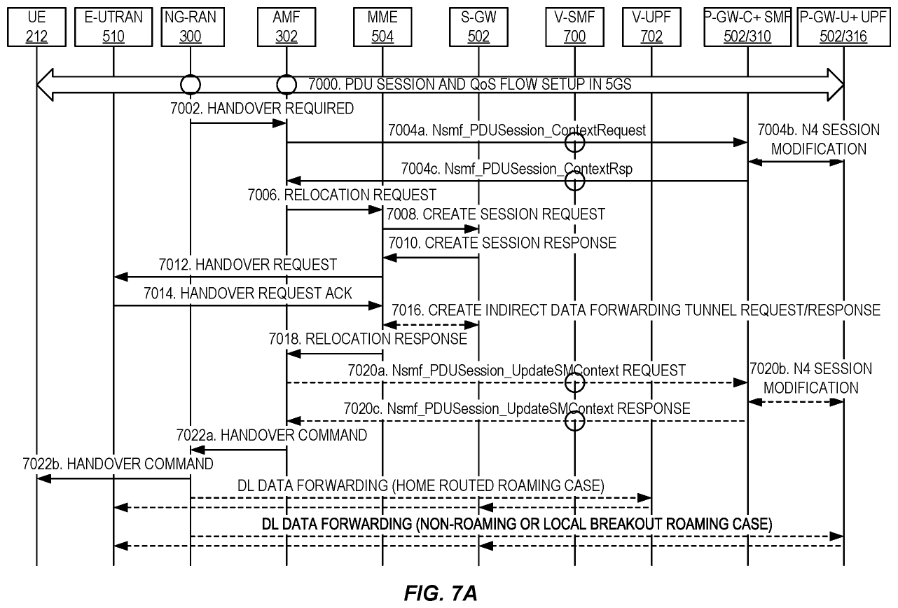

FIG. 8 is a schematic block diagram of a network node 800 according to some embodiments of the present disclosure. The network node 800 may be, for example, radio access node (e.g., a base station 202 or 206), a core network node (e.g., a MME), or a network node implementing a core network function (e.g., a network node implementing a 5GC NF). As illustrated, the network node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, if the network node 800 is a radio access node, the network node 800 includes one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a network node 800 as described herein (e.g., function(s) of an eNB, MME, or AMF as described above with respect to FIGS. 6A and 6B or FIGS. 7A and 7B). In some embodiments, the function(s) are implemented in software that is stored, e.g., in the memory 806 and executed by the one or more processors 804.

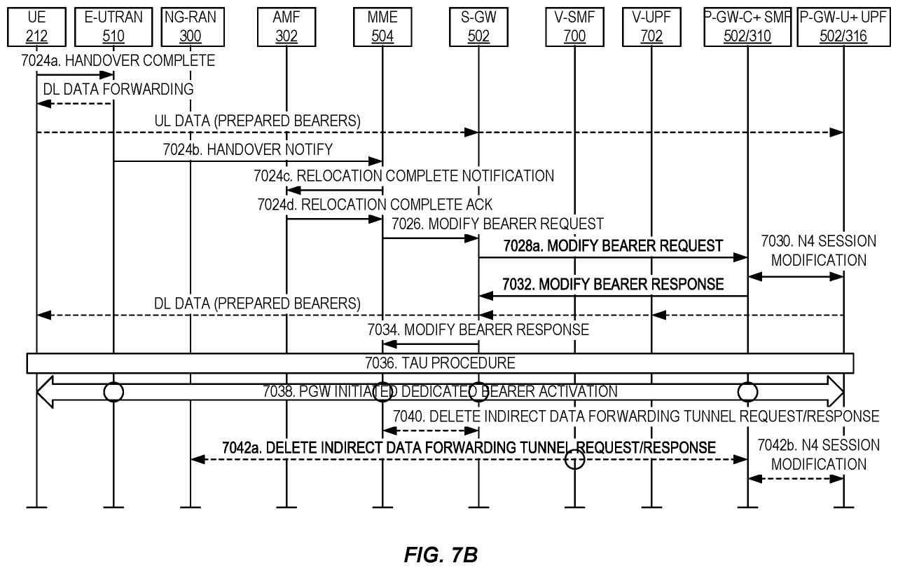

FIG. 9 is a schematic block diagram that illustrates a virtualized embodiment of the network node 800 according to some embodiments of the present disclosure. This discussion is equally applicable to other types of network nodes. Further, other types of network nodes may have similar virtualized architectures.

As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902 via. Each processing node 900 includes one or more processors 904 (e.g., CPUs, ASICs, FPGAs, and/or the like), memory 906, and a network interface 908. The network node 800 may also include the control system 802 that includes the one or more processors 804 (e.g., CPUs, ASICs, FPGAs, and/or the like), the memory 806, and the network interface 808 and/or, if the network node 800 is a radio access node, the one or more radio units 810 that each includes the one or more transmitters 812 and the one or more receivers 814 coupled to the one or more antennas 816, as described above.

In this example, functions 910 of the network node 800 described herein (e.g., function(s) of an eNB, MME, or AMF as described above with respect to FIGS. 6A and 6B or FIGS. 7A and 7B) are implemented at the one or more processing nodes 900 or distributed across the control system 802 and the one or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

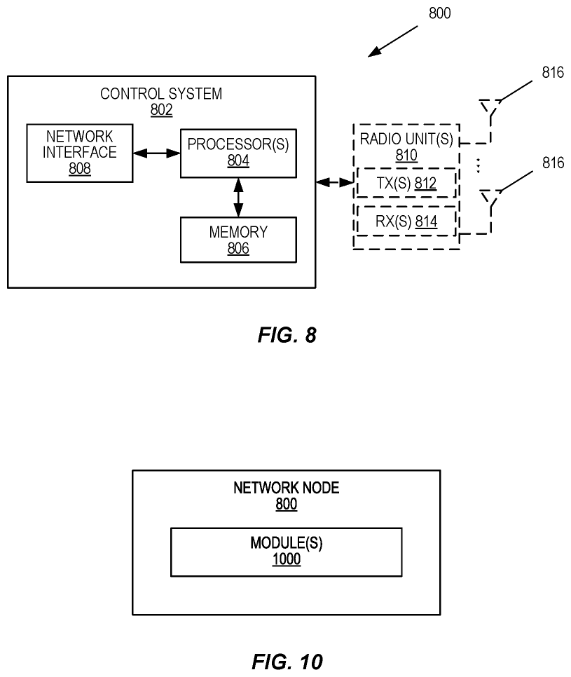

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein (e.g., function(s) of an eNB, MME, or AMF as described above with respect to FIGS. 6A and 6B or FIGS. 7A and 7B). This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

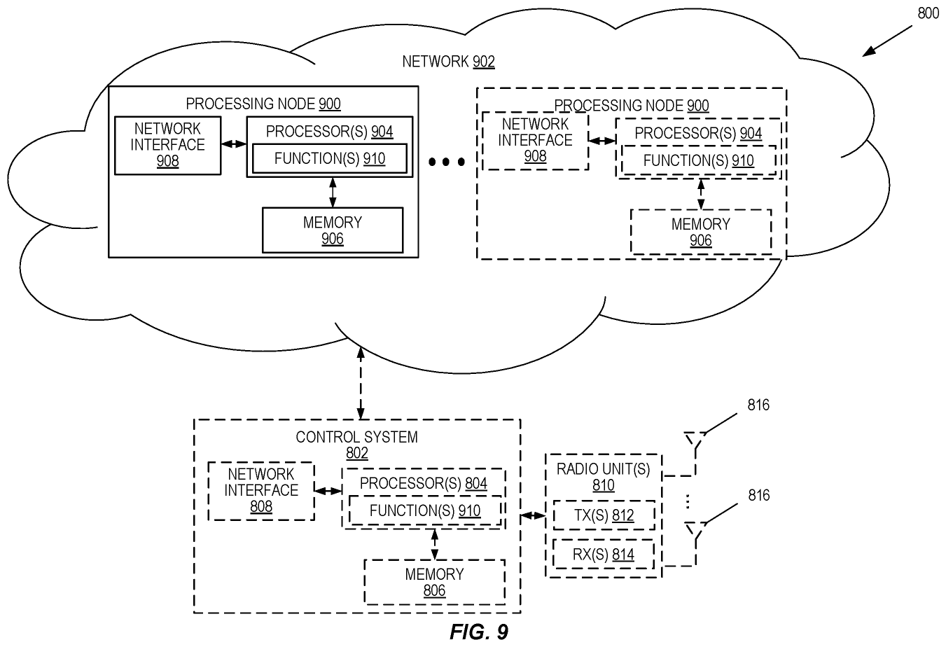

FIG. 11 is a schematic block diagram of a UE 1100 according to some embodiments of the present disclosure. As illustrated, the UE 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the UE 1100 described above (e.g., function(s) of UE as described above with respect to FIGS. 6A and 6B or FIGS. 7A and 7B) may be fully or partially implemented in software that is, e.g., stored in the memory 1104 and executed by the processor(s) 1102. Note that the UE 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the UE 1100 and/or allowing output of information from the UE 1100), a power supply (e.g., a battery and associated power circuitry), etc.

In some embodiments, a computer program including instructions which, when executed by at least one processor, causes the at least one processor to carry out the functionality of the UE 1100 according to any of the embodiments described herein (e.g., function(s) of UE as described above with respect to FIGS. 6A and 6B or FIGS. 7A and 7B) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

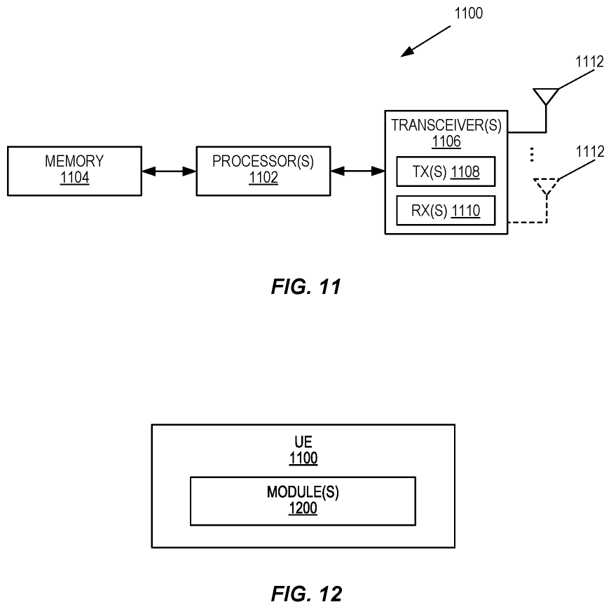

FIG. 12 is a schematic block diagram of the UE 1100 according to some other embodiments of the present disclosure. The UE 1100 includes one or more modules 1200, each of which is implemented in software. The module(s) 1200 provide the functionality of the UE 1100 described herein (e.g., function(s) of UE as described above with respect to FIGS. 6A and 6B or FIGS. 7A and 7B).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows.

Embodiment 1: A method performed by a wireless device for redirecting from a first wireless communication system using a first radio access type to a second wireless communication system using a second radio access type after having performed a service request in the first wireless communication system for an emergency call, the method comprising transmitting (6000A) a connection request message to a base station in the second wireless communication system as part of a connection establishment procedure whereby the wireless device establishes a connection to the second wireless communication system, the connection request message comprising an indication that a cause of connection establishment is an emergency.

Embodiment 2: The method of embodiment 1 further comprising transmitting (6004) a tracking area update request to the base station and receiving (6034) a tracking area update accept message from the base station.

Embodiment 3: The method of embodiment 1 or 2 wherein the connection request message is a Radio Resource Control, RRC, Connection Request.

Embodiment 4: The method of any one of embodiments 1 to 3 wherein the first wireless communication system is a Fifth Generation System, 5GS, and the second wireless communication system is an Evolved Packet System, EPS.

Embodiment 5: A wireless device for redirecting from a first wireless communication system using a first radio access type to a second wireless communication system using a second radio access type after having performed a service request in the first wireless communication system for an emergency call, the wireless device adapted to perform the method of any one of embodiments 1 to 4.

Embodiment 6: A wireless device for redirecting from a first wireless communication system using a first radio access type to a second wireless communication system using a second radio access type after having performed a service request in the first wireless communication system for an emergency call, the wireless device comprising: one or more transmitters; and processing circuitry associated with the one or more transmitters, the processing circuitry configured to cause the wireless device to perform the method of any one of embodiments 1 to 4.

Embodiment 7: A method performed by a network node for redirecting a wireless device from a first wireless communication system using a first radio access type to a second wireless communication system using a second radio access type after the wireless device having performed a service request in the first wireless communication system for an emergency call, the network node being in the second wireless communication system, the method comprising receiving (step 6000A) a connection request message from the wireless device as part of a connection establishment procedure whereby a connection between the wireless device and the second wireless communication system is established, the connection request message comprising an indication that a cause of connection establishment is an emergency.

Embodiment 8: The method of embodiment 7 further comprising receiving (6004) a tracking area update request from the wireless device and sending (6006) a message to a second network node as part of a tracking area update procedure, the message sent to the second network node comprising an emergency indication.

Embodiment 9: The method of embodiment 8 wherein the network node is a base station and the second network node is a core network node.

Embodiment 10: The method of embodiment 8 or 9 wherein: the first wireless communication system is a Fifth Generation System, 5GS; the second wireless communication system is an Evolved Packet System, EPS; the network node is an enhanced or evolved Node B, eNB; and the second network node is a Mobility Management Entity, MME.

Embodiment 11: The method of any one of embodiments 8 to 10 further comprising receiving (6034), from the second network node in association with a tracking area update accept message, an emergency fallback indication.

Embodiment 12: The method of any one of embodiments 7 to 11 wherein the connection request message is a Radio Resource Control, RRC, Connection Request.

Embodiment 13: The method of any one of embodiments 1 to 12 wherein, as a result of the indication, the network node gives the wireless device emergency treatment.

Embodiment 14: A method performed by a network node for redirecting a wireless device from a first wireless communication system using a first radio access type to a second wireless communication system using a second radio access type after the wireless device having performed a service request in the first wireless communication system for an emergency call, the network node being in the first wireless communication system, the method comprising: receiving (6008), from a second network node in the second wireless communication system, a context request message as part of a tracking area update procedure; and sending (6012), to the second network node, a context request response message comprising an emergency fallback indicator.

Embodiment 15: The method of embodiment 14 wherein the network node is an Access and Mobility Management Function, AMF.

Embodiment 16: The method of embodiment 14 or 15 wherein the second network node is a Mobility Management Entity, MME.

Embodiment 17: A method performed by a network node for redirecting a wireless device from a first wireless communication system using a first radio access type to a second wireless communication system using a second radio access type after the wireless device having performed a service request in the first wireless communication system for an emergency call, the network node being in the second wireless communication system, the method comprising: receiving, (6006), a tracking area update request from a base station in the second wireless communication system;

sending (6008), to a second network node in the first wireless communication system, a context request message as part of a tracking area update procedure; receiving (6012), from the second network node, a context request response message comprising an emergency fallback indicator; and sending (6034), to the base station in association with a tracking area update accept, a message comprising an emergency fallback indicator.

Embodiment 18: The method of embodiment 17 wherein the network node is a Mobility Management Entity, MME.

Embodiment 19: The method of embodiment 17 or 18 wherein the second network node is an Access and Mobility Management Function, AMF.

Embodiment 20: A method performed by a network node during an Inter-Radio Access Technology, IRAT, handover procedure performed for handover of a wireless device from a first wireless communication system using a first radio access type to a second wireless communication system using a second radio access type after the wireless device having performed a service request in the first wireless communication system for an emergency call, the network node being in the first wireless communication system, the method comprising sending (7006), to a second network node in the second wireless communication system during the IRAT handover procedure, a forward location request, the forward location request comprising an emergency fallback indicator.

Embodiment 21: The method of embodiment 20 wherein the second network node is a Mobility Management Entity, MME.

Embodiment 22: The method of embodiment 20 or 21 wherein the network node is an Access and Mobility Management Function, AMF.

Embodiment 23: A method performed by a first network node during an Inter-Radio Access Technology, IRAT, handover procedure performed for handover of a wireless device from a first wireless communication system using a first radio access type to a second wireless communication system using a second radio access type after the wireless device having performed a service request in the first wireless communication system for an emergency call, the first network node being in the second wireless communication system, the method comprising sending (7012), to a base station in the second wireless communication system during the IRAT handover procedure, a handover request comprising an emergency fallback indicator.

Embodiment 24: The method of embodiment 23 wherein the first network node is a Mobility Management Entity, MME.

Embodiment 25: The method of embodiment 23 or 24 further comprising, prior to sending the handover request, receiving (7006), from a second network node in the first wireless communication system during the IRAT handover procedure, a forward location request, the forward location request comprising an emergency fallback indicator.

Embodiment 26: A method performed by a base station during an Inter-Radio Access Technology, IRAT, handover procedure performed for handover of a wireless device from a first wireless communication system using a first radio access type to a second wireless communication system using a second radio access type after the wireless device having performed a service request in the first wireless communication system for an emergency call, the base station being in the second wireless communication system, the method comprising sending (7014), to a core network node in the second wireless communication system during the IRAT handover procedure, a handover request acknowledgement comprising an emergency fallback indicator.

Embodiment 27: The method of embodiment 23 further comprising, prior to sending the handover request acknowledgment, receiving, from a network node in the first wireless communication system, a message comprising a source to target transparent container, the source to target transparent container comprising an emergency fallback indicator.

Embodiment 28: A network node adapted to perform the method of any one of embodiments 7 to 27.

Embodiment 29: A network node comprising processing circuitry configured to cause the network node to perform the method of any one of embodiments 7 to 27.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
4G Fourth Generation
5G Fifth Generation
5GC Fifth Generation Core
5GS Fifth Generation System
ACK Acknowledgement
AF Application Function
AMF Access and Mobility Management Function
AN Access Network
ASIC Application Specific Integrated Circuit
AUSF Authentication Server Function
CPU Central Processing Unit
DECOR Dedicated Core
DN Data Network
DSP Digital Signal Processor
eNB Enhanced or Evolved Node B
EN-DC Evolved Universal Terrestrial Radio Access New Radio Dual

Connectivity
EPC Evolved Packet Core
EPS Evolved Packet System
E-UTRA Evolved Universal Terrestrial Radio Access
E-UTRAN Evolved Universal Terrestrial Radio Access Network
FPGA Field Programmable Gate Array
gNB New Radio Base Station
HO Handover
HSS Home Subscriber Server
IMS Internet Protocol Multimedia Subsystem
IP Internet Protocol
IRAT Inter-Radio Access Technology
LTE Long Term Evolution
MME Mobility Management Entity
MTC Machine Type Communication
NEF Network Exposure Function
NF Network Function
NG-RAN Next Generation Radio Access Network
NR New Radio
NRF Network Repository Function
NSSF Network Slice Selection Function
PCF Policy Control Function
PCRF Policy and Charging Rules Function
PDN Packet Data Network
PDU Protocol Data Unit
P-GW Packet Data Network Gateway
QoS Quality of Service
RAM Random Access Memory
RAN Radio Access Network
ROM Read Only Memory
RRC Radio Resource Control
RRH Remote Radio Head
RTT Round Trip Time
SCEF Service Capability Exposure Function
S-GW Serving Gateway
SMF Session Management Function
TAU Tracking Area Update
TS Technical Specification
UDM Unified Data Management
UE User Equipment
UPF User Plane Function
VoLTE Voice over Long Term Evolution

Those skilled in the art will recognize improvements and modifications to the embodiments of the present disclosure. All such improvements and modifications are considered within the scope of the concepts disclosed herein.

1. A method performed for redirecting a wireless device from a first wireless communication system using a first radio access type to a second wireless communication system using a second radio access type after the wireless device having performed a service request in the first wireless communication system for an emergency call, the method comprising:
at the wireless device:
transmitting a connection request message to a base station in the second wireless communication system as part of a connection establishment procedure whereby the wireless device establishes a connection to the second wireless communication system, the connection request message comprising an indication that a cause of connection establishment is an emergency;
at the base station:
receiving the connection request message from the wireless device as part of the connection establishment procedure;
receiving a tracking area update request from the wireless device during a tracking area update procedure; and
sending the tracking area update request to a first network node, the first network node being part of the second wireless communication system;
sending a message to the first network node as part of the tracking area update procedure, the message sent to the first network node comprising an emergency indication;
at the first network node:
receiving the tracking area update request and the message comprising the emergency indication from the base station as part of the tracking area update procedure;
sending, to a second network node in the first wireless communication system, a context request message as part of the tracking area update procedure;
receiving, from the second network node, a context request response message comprising an emergency fallback indicator; and
sending, to the base station, in association with a tracking area update accept, a message comprising an emergency fallback indicator; and
at the second network node:
receiving the context request message from the first network node; and
sending the context request response message comprising the emergency fallback indicator to the first network node.

2-8. (canceled)

9. A method performed by a network node, the method comprising:
redirecting a wireless device from a first wireless communication system using a first radio access type to a second wireless communication system using a second radio access type after the wireless device having performed a service request in the first wireless communication system for an emergency call, the network node being in the second wireless communication system, wherein redirecting the wireless device comprises receiving a connection request message from the wireless device as part of a connection establishment procedure whereby a connection between the wireless device and the second wireless communication system is established, the connection request message comprising an indication that a cause of connection establishment is an emergency.

10. The method of claim 9 further comprising:
receiving a tracking area update request from the wireless device as part of a tracking area update procedure; and
sending a message to a second network node as part of the tracking area update procedure, the message sent to the second network node comprising an emergency indication.

11. The method of claim 10 wherein the network node is a base station and the second network node is a core network node.

12. The method of claim 10 wherein:
the first wireless communication system is a Fifth Generation System, 5GS;
the second wireless communication system is an Evolved Packet System, EPS;
the network node is an enhanced or evolved Node B, eNB; and
the second network node is a Mobility Management Entity, MME.

13. The method of claim 10 further comprising receiving, from the second network node in association with a tracking area update accept, a message comprising an emergency fallback indication.

14. The method of claim 9 wherein the connection request message is a Radio Resource Control, RRC, Connection Request.

15. The method of claim 9 wherein, as a result of the indication, the network node gives the wireless device emergency treatment.

16-17. (canceled)

18. A network node comprising:
processing circuitry configured to cause the network node to redirect a wireless device from a first wireless communication system using a first radio access type to a second wireless communication system using a second radio access type after the wireless device having performed a service request in the first wireless communication system for an emergency call, the network node being in the second wireless communication system, wherein the processing circuitry is configured to cause the network node to redirect the wireless device by causing the network node to receive the connection request message from the wireless device as part of the connection establishment procedure.

19. A method performed by a network node for redirecting a wireless device from a first wireless communication system using a first radio access type to a second wireless communication system using a second radio access type after the wireless device having performed a service request in the first wireless communication system for an emergency call, the network node being in the second wireless communication system, the method comprising:
receiving a tracking area update request from a base station in the second wireless communication system as part of a tracking area update procedure;
sending, to a second network node in the first wireless communication system, a context request message as part of the tracking area update procedure;
receiving, from the second network node, a context request response message comprising an emergency fallback indicator; and
sending, to the base station in association with a tracking area update accept, a message comprising an emergency fallback indicator.

20. The method of claim 19 wherein the network node is a Mobility Management Entity, MME.

21. The method of claim 19 wherein the second network node is an Access and Mobility Management Function, AMF.

22-23. (canceled)

24. A network node for redirecting a wireless device from a first wireless communication system using a first radio access type to a second wireless communication system using a second radio access type after the wireless device having performed a service request in the first wireless communication system for an emergency call, the network node being in the second wireless communication system, wherein the network node comprises:
processing circuitry configured to cause the network node to:
receive the tracking area update request from the base station;
send the context request message to the second network node;
receive the context request response message from the second network node; and
send, in association with the tracking area update accept, the message to the base station.

25. A method performed by a network node for redirecting a wireless device from a first wireless communication system using a first radio access type to a second wireless communication system using a second radio access type after the wireless device having performed a service request in the first wireless communication system for an emergency call, the network node being in the first wireless communication system, the method comprising:
receiving, from a second network node in the second wireless communication system, a context request message as part of a tracking area update procedure for the wireless device; and
sending, to the second network node, a context request response message comprising an emergency fallback indicator.

26. The method of claim 25 wherein the network node is an Access and Mobility Management Function, AMF.

27. The method of claim 25 wherein the second network node is a Mobility Management Entity, MME.

28-29. (canceled)

30. A network node for redirecting a wireless device from a first wireless communication system using a first radio access type to a second wireless communication system using a second radio access type after the wireless device having performed a service request in the first wireless communication system for an emergency call, the network node being in the first wireless communication system, the network node comprising:
processing circuitry configured to cause the network node to:
receive the context request message from the second network node; and
send the context request response message to the second network node.

31-57. (canceled)
